(19) United States
(12) Patent Application Publication
(10) Pub. No.: US 2007/0027053 A1
(43) Pub. Date: Feb. 1, 2007

(54) Detergent composition comprising coated bleach particle

(75) Inventor: Giuseppe Di Bono, Mira (IT)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofddorp (NL)

(21) Appl. No.: 10/575,823

(22) PCT Filed: Sep. 16, 2004
(86) PCT No.: PCT/GB04/03955

§ 371 Date: Jul. 5, 2006

(30) Foreign Application Priority Data
Oct. 16, 2003 (GB) 0324245.0

(51) Int. Cl. C11D 3/395

(52) U.S. Cl. 510/302; 510/392

(57) ABSTRACT

The present invention relates to detergent compositions containing incompatible ingredients, like enzymes and bleach, which can be used to clean various surfaces including but not limited to, hard surfaces as well as fabrics, clothes, carpets, wherein a bleach is encapsulated in coating digestible by an enzyme present in the composition.

The present invention relates to detergent compositions containing incompatible ingredients, like enzymes and bleach, which can be used to clean various surfaces including but not limited to, hard surfaces as well as fabrics, clothes, carpets and the like, wherein a bleach is encapsulated in a coating digestible by an enzyme present in the composition.

Detergent compositions for removal or cleaning stains on fabrics and/or hard surfaces typically contain bleaching agents. These can be divided into two groups: oxygen bleaches (typically peroxides) and halogen bleaches (typically chlorine bleaches). Their action is based on the oxidation of the molecules present in the stains.

Besides this, detergent compositions typically contain enzymes, typically from the groups of proteases, amylases and lipases. Enzymes are proteins and are susceptible to oxidative degradation such as from the bleaches that are present in the composition. It is known in the art that, though very effective to remove stains, bleaching agents also present a number of drawbacks to product stability when used. For example, bleaching agents, when in contact with perfumes or enzymes, partially or totally inactivate these molecules, thus causing a loss of performance. The incompatibility of these ingredients is a problem well known in the art and certain solutions have been found, such as in the use of discrete layers in laundry tablets. However, in the field of liquid detergents segregation is more difficult and the usual solutions are to encapsulate one or the other mutually incompatible ingredients—typically to encapsulate the bleach since that it is unstable in the presence of water.

Furthermore, it is known in the art that bleaching agents may reduce the effectiveness of enzymes on some stains because they chemically modify the structure of the stains thus inhibiting, partially or totally, the capability of the enzyme to attack the stains themselves.

The present invention thus provides a coating for bleaching agents which is digestible by an enzyme present in the composition which is stable in the product environment whilst easily removable in the wash bath, thus making them usable in the formulation of detergents containing enzymes and other ingredients incompatible with bleach.

The coated bleaching agents according to the present invention may be useful in any laundry and hard surface cleaning application, e.g., as in laundry detergents, laundry additives or dish washing detergents. A particular advantage of the present invention is that the material used for the coating of the bleach is fully biodegradable, thus making it ecologically acceptable.

Another advantage of the present invention is that it allows the formulation of stable detergent compositions containing incompatible raw materials (typically enzymes and bleach), thus improving the cleaning performance of the formulation itself.

Yet another advantage of a coating described in the present invention is that it is degraded by the enzymes present in the detergent composition in the wash bath, making bleach available only once the enzymes have at least started their action and thus reducing the interference between the two actives.

U.S. Pat. No. 5,589,370 Unilever describes a continuous process for curing capsules which contain “sensitive ingredients”, typically enzymes are described as the material encapsulated using a suitable cross linking polymer material. EP0554359 Unilever describes the use of cationic proteins of MW of 1 k to 50 k as being useful in stabilising enzymes or bleach compounds in heavy duty laundry detergent liquids. EP0653485 Unilever describes enzyme and bleach containing capsules.

According to the present invention there is provided a detergent composition, preferably a liquid, comprising an enzyme and a coated bleaching, wherein the coating material of the bleaching agent is a substrate for the at least one enzyme, preferably the material being selected from the group consisting of protein, either of animal or vegetal origin, starch, fat and a mixture thereof, preferably the material is a protein.

Ideally the enzyme is separated from the coating of the bleaching agent, for example, by being coated or physically segregated.

Preferably the enzyme is inactive in the detergent but active in the wash. Enzymes may be inactive due to the presence of a coating which is sensitive to a change of one or more physical parameters, like pH, temperature, osmotic pressure or ionic strength.

Preferably the composition according to the present invention is a liquid, and ideally is an aqueous liquid. Thus the composition preferably has a water content of from 5% to 99%, more preferably from 10% to 95%, more preferably from 20% to 90% by weight of the composition.

The compositions according to the present invention ideally have a pH from 1 to 14, preferably from 2 to 14 and more preferably from 4 to 12.

Alternatively the composition may be a solid such as a powder or a shaped article, such as a tablet. If the product is a solid then the enzyme is preferably physically separated from the coated bleaching agent.

The compositions according to the present invention ideally contain enzymes from the classes of proteases, lipases and amylases or combinations thereof.

Said bleaching agents are preferably coated with a protein film having thickness from 10μ to 1000μ, more preferably from 50μ to 500μ and more preferably from 100μ to 300μ.

Proteins suitable for coating can be selected are chosen from the group consisting of vegetable proteins, including but not limited to gluten, soybean, or a combination thereof, and from the group consisting of animal proteins, including but not limited to albumin, gelatin, lactoproteins, or a combination thereof.

Coating characteristics like hydrophobicity, colour, resistance to bacteria and fungi can be provided by adding to the protein additives like hydrophobic substances, colourants, bactericide or fungicide substances.

Hydrophobic substances can be used to reduce water permeability of the coating. They can be chosen from oils, waxes, emulsifiers and mixtures thereof.

Colourants and dyes can be used to provide the coating with different colours. They can be chosen from pigments, dyes and mixtures thereof.

Bactericide and fungicide substances can be optionally used to increase the resistance of the coating to the attack of microorganisms.

Bleaching Agent

The composition according to the present invention ideally contains a bleaching agent from the classes of halogen bleaches or oxygen bleaches, having average size from 100μ to 2500μ, more preferably from 500μ to 2000μ and more preferably from 700μ to 1500μ.

In one preferred aspect the oxygen-releasing bleaching agent contains a hydrogen peroxide source and an organic peroxyacid bleach precursor compound. The production of the organic peroxyacid occurs by an in situ reaction of the precursor with a source of hydrogen peroxide. Preferred sources of hydrogen peroxide are inorganic perhydrate bleaches.

Inorganic Perhydrate Bleaches

Suitable hydrogen peroxide sources include the inorganic perhydrate salts.

The inorganic perhydrate bleaches or salts thereof are normally incorporated in the form of the sodium salt at a level of from 1% to 40% by weight, more preferably from 2% to 30% by weight and most preferably from 5% to 25% by weight of the compositions.

Examples of inorganic perhydrate bleaches and their salts include perborate, percarbonate, perphosphate, persulfate and persilicate salts. The inorganic perhydrate are normally the alkali metal salts. The inorganic perhydrate bleach may be included as the crystalline solid without additional protection.

Sodium perborate can be in the form of the monohydrate of nominal formula NaBO₂.H₂O₂ or the tetrahydrate NaBO₂.H₂O₂.4H₂O.

Alkali metal percarbonates, particularly sodium percarbonate are preferred perhydrates for inclusion in compositions in accordance with the invention. Sodium percarbonate is an addition compound having a formula corresponding to 2Na₂CO₃.3H₂O₂, and is available commercially as a crystalline solid. Sodium percarbonate, being a hydrogen peroxide addition compound tends on dissolution to release the hydrogen peroxide quite rapidly which can increase the tendency for localised high bleach concentrations to arise. Therefore, an additional advantage of the invention is provided by the coating to the bleach providing controlled release of the bleach (by “controlled” we mean that release is not effected immediately upon use).

Peroxyacid Bleach and Precursors

Organic peroxy acids or the precursors therefor may also be utilized as part of the bleach agent. The peroxyacids usable in the present invention are solid and, preferably, substantially water-insoluble compounds. By “substantially water-insoluble” is meant herein a water-solubility of less than about 1% by weight at ambient temperature. In general, peroxyacids containing at least about 7 carbon atoms are sufficiently insoluble in water for use herein.

Typical monoperoxy acids useful herein include alkyl peroxy acids and aryl peroxyacids such as:

(i) peroxybenzoic acid and ring-substituted peroxybenzoic acids, e.g. peroxy-alpha-naphthoic acid;

(ii) aliphatic and substituted aliphatic monoperoxy acids, e.g. peroxylauric acid and peroxystearic acid;

(iii) phthaloyl amido peroxy caproic acid (PAP).

Typical diperoxy acids useful herein include alkyl diperoxy acids and aryldiperoxy acids, such as:

(iv) 1,12-diperoxydodecanedioic acid (DPDA);

(v) 1,9-diperoxyazelaic acid;

(vi) diperoxybrassylic acid; diperoxysebacic acid and diperoxyisophthalic acid;

(vii) 2-decyldiperoxybutane-1,4-dioic acid.

Peroxyacid bleach precursors are well known in the art. As non-limiting examples can be named N,N,N′,N′-tetraacetyl ethylene diamine (TAED), sodium nonanoyloxybenzene sulphonate (SNOBS), sodium benzoyloxybenzene sulphonate (SBOBS) and the cationic peroxyacid precursor (SPCC) as described in U.S. Pat. No. 4,751,015.

Metal-Containing Bleach Catalyst

The bleaching agent described herein may additionally contain as a preferred component, a metal containing bleach catalyst. Preferably the metal containing bleach catalyst is a transition metal containing bleach catalyst, more preferably a manganese or cobalt-containing bleach catalyst, but may be based upon iron or copper. Ideally the bleach catalyst is found with the other components of the bleaching agent inside the capsulate or it may be found in the liquid of the detergent composition or in the form of a second encapsulate.

A suitable type of bleach catalyst is a catalyst comprising a heavy metal cation, such as copper, iron cations, an auxiliary metal cation having little or no bleach catalytic activity, such as zinc or aluminium cations, and a sequestrant having defined stability constants for the catalytic and auxiliary metal cations, particularly ethylenediaminetetraacetic acid, ethylenediaminetetra (methylenephosphonic acid) and water-soluble salts thereof. Such catalysts are disclosed in U.S. Pat. No. 4,430,243.

Preferred types of bleach catalysts include the manganese-based complexes disclosed in U.S. Pat. No. 5,246,621 and U.S. Pat. No. 5,244,594. Others are described in European patent application publication no. 549,272. Other ligands suitable for use herein include 1,5,9-trimethyl-1,5,9-triazacyclododecane, 2-methyl-1,4,7-triazacyclononane, 2-methyl-1,4,7-triazacyclononane, 1,2,4,7-tetramethyl-1,4,7-triazacyclononane, and mixtures thereof.

Chlorine or Bromine Releasing Bleaches

The bleaching agent to be encapsulated in the coating may be a chlorine- or bromine-releasing agent. Among suitable reactive chlorine- or bromine-oxidizing materials are heterocyclic N-bromo and N-chloro imides such as trichloroisocyanuric, tribromoisocyanuric, dibromoisocyanuric and dichloroisocyanuric acids, and salts thereof with water-solubilising cations such as potassium and sodium. Hydantoin compounds such as 1,3-dichloro-5,5-dimethyl-hydantoin are also suitable.

Dry, particulate, water-soluble anhydrous inorganic salts are likewise suitable for use herein such as lithium, sodium or calcium hypochlorite and hypobromite. Chlorinated trisodium phosphate is another core material. Chloroisocyanurates are, however, the preferred bleaching agents. Potassium dichloroisocyanurate is sold by Monsanto Company as ACL-59™. Sodium dichloroisocyanurates are also available from Monsanto as ACL-60™, and in the dihydrate form, from the Olin Corporation as Clearon CDB-56™, available in powder form (particle diameter of less than 150 microns); medium particle size (about 50 to 400 microns); and coarse particle size (150-850 microns). Very large particles (850-1700 microns) are also found to be suitable for encapsulation.

Enzyme Coating

In one embodiment of the invention the enzyme may also be coated. A requirement of the feature of the invention is that the enzyme coating dissolves easily to aid the dissolution of the bleaching agent coating. The enzyme, preferably a protease, may be coated by any suitable known means or any suitable material. Examples of such are provided below

A suitable coating material providing in product stability comprises mixed salt of a water soluble alkali metal sulphate and carbonate. Such coatings together with coating processes have previously been described in GB-1,466,799. The weight ratio of the mixed salt coating material to percarbonate lies in the range from 1:200 to 1:4, more preferably from 1:99 to 1:9, and most preferably from 1:49 to 1:19. Preferably, the mixed salt is of sodium sulphate and sodium carbonate which has the general formula Na₂SO₄.n.Na₂CO₃ wherein n is from 0.1 to 3, preferably n is from 0.3 to 1.0 and most preferably n is from 0.2 to 0.5.

Another suitable coating material providing in product stability, comprises sodium silicate of SiO₂:Na₂O ratio from 1.8:1 to 3.0:1, preferably 1.8:1 to 2.4:1, and/or sodium metasilicate, preferably applied at a level of from 2% to 10%, (normally from 3% to 5%) of SiO₂ by weight of the inorganic perhydrate salt. Magnesium silicate can also be included in the coating. Coatings that contain silicate and borate salts or boric acids or other inorganics are also suitable.

Suitable coating materials include triglycerides (e.g. partially) hydrogenated vegetable oil, soy bean oil, cotton seed oil) mono or diglycerides, microcrystalline waxes, gelatin, cellulose, fatty acids and any mixtures thereof.

Suitable coating techniques are described below for the bleaching agent.

Detergent Enzymes

The additional detergent compositions can further comprise one or more enzymes which provide cleaning performance, fabric care and/or sanitisation benefits.

Said enzymes include one or more enzymes selected from proteases, cellulases, hemicellulases, peroxidases, bluco-amylases, amylases, xylanaes, lipases, phospholipases, esterases, cutinases, pectinases, keratanases, reductases, oxidases, phenoloxidases, lipoxygenases liginases, pullulanases, tannases, pentosanases, malanases, R-glucanases, arabinosidases, hyaluronidase, chondroitinase, laccase or mixtures thereof.

An essential feature of the invention is that at least one enzyme is used that is capable of digesting the material used to encapsulate the bleach.

A preferred combination is a detergent composition having cocktail of conventinal applicable enzymes like amylase, lipase cutinase and/or cellulase in conjunction with one or more plant cell wall degrading enzymes.

The cellulases usable in the present invention include both bacterial or fungal cellulases. Preferably, they will have a pH optimum of between 5 or 12 and an activity above 50 CEVU (Cellulose Viscosity Unit). Suitable cellulases are disclosed in U.S. Pat. No. 6,107,8384 and WO 96/02653 which discloses fungal cellulase produced respectively from Humicola insolens, Trichoderma, Thielavia and Sporotrichum. EP 739 982 describes cellulases isolated from novel Bacillus species. Suitable cellulases are also disclosed in GB-A-2.075.028; GB-A-2.095.275; DE-OS-2.247.832 and WO 95/26398.

Examples of such cellulases are cellulases produced by a strain og Humicola insolens (Humicola grisea var. thermoidea), particularly the Humicola strain DSM 1800.

Other suitable cellulases are cellulases originated from Humicola insolens having a molecular weight of about 50 KDa, an isoeletric point of 5.5 and containing 415 amino acids; and a 43 kD endoglucanase derived from Humicola insolens, DSM 1800, exhibiting cellulase activity; a preferred endoglucanase component has the amino acid sequence disclosed in PCT Patent Application No. WO 91/17243.

Also suitable cellulases are the EGIII celulases from Trichoderma longibrachiatum described in WO 94/21801, Genencor, published Sep. 29, 1994. Especially sutiable cellulases are the cellulases having colour care benefits.

Examples of such cellases are cellulases described in European patent application No. 91202879.2, filed Nov. 6, 1991 (Novo). Carezyme and Celluzyme (Novo Nordis, A/S) are especially useful. See also WO 91/17244 and WO 91/21801. Other suitable cellulases for fabric care and/or cleaning properties are described in WO 96/34902, WO 96/17994 and WO 95/24471.

Said cellulases are normally incorporated in the detergent composition at levels from 0.0001% to 2% of pure enzyme by weight of the detergent composition.

Peroxidase enzymes are used in combination with oxygen sources, eg percarbonate, perborate, persulfate and hydrogen peroxide, and with a phenolic substrate as bleach enhancing molecule.

They are used for “solution bleaching”, i.e. to prevent transfer of dyes or pigments removed from substrates during wash operations to other substrates in the wash solution. eroxidase enzymes are known in the art, and include, for example, horseradish peroxidase, ligninase and haloperoxidase such as chloro- and bromo-peroxidase. Peroxidase-containing detergent compositions are disclosed, for example, in WO 89/099813 and WO 89/09813. Also suitable is the laccase enzyme.

Enhancers are generally comprised at a level of from 0.1% to 5% by weight of total composition. Preferred enchancers are substituted phenthiazine and phenoxasine 10-phenothiazinepropionic acid (PPT), 10-ethylhenothiazine-4-carboxylic acid (EPC), 10-phenoxazinepropionic acid (POP) and 10 methylphenoxazine (described in WO 94/12621) and substituted syringates (C3 CS substituted alkyl syringates) and phenols. Sodium percarbonate or perborate are preferred sources of hydrogen peroxide.

Said peroxidases are normally incorporated in the detergent composition at levels from 0.0001% to 2% of pure enzyme by weight of the detergent composition.

Other preferred enzymes that can be included in the detergent compositions of the present invention include lipases. Suitable lipase enzymes for detergent usage include those produced by microorganisms of the Pseudomonas group, such as Pseudomonas stutzeri ATCC 19.154, as disclosed in British Patent 1,372,034. Suitable lipases include those which show a positive immunological cross-reaction with the antibody of the lipase produced by the microorganism Pseudomonas fluorescent IAM 1057. This lipase is available from Amano Pharmceutical Co Ltd., Nagoya, Japan, under the trade name Lipase P “Amano”. Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., USA an Disoynth CO., The Netherlands, and lipases ex Pseudomonas gladioli. Especially suitable lipases are lipases such as M 1 Lipase® and Lipomax® (Gist-Brocades) and Lipolase® and Lipolase Ultra® (Novo) which have found to be very effective when used in combination with the compositions of the present invention. Also suitable are the lipolytic enzymes described in EP 258 068, WO 92/05249 and WO 95/22615 by Novo Nordisk and in WO 94/03578, WO 95/35381 and WO 96/00292 by Unilever.

Also suitable are cutinases which can be considered as a special kind of lipase, namely lipases which do not require interfacial activation. Addition of cutinases to detergent compositions have been described in e.g. WO A88/09367 (Genencor); WO 90/09446 (Plant Genetic) and WO 94/14963 and WO 94/14964 (Unilever).

The lipases and/or cutinases are normally incorporated in the detergent composition at levels from 0.0001% to 2% of pure enzyme by weight of the detergent composition.

Amylases (a and/or f) can be included for removal of carbohydrate-based stains. WO 94/02597, Novo Nordis, A/S published Feb. 3, 1994, describes detergent compositions which incorporate mutant amylases. Se also WO 95/10603, Novo Nordisk A/S, published Apr. 20, 1995. Other amylases known for use in detergent compositions include both a- and ss-amylases.

Amylases are stability-enhanced amylases described in WO 94/18314, published Aug. 18, 1994 and WO 96/05295, Genencor, published Feb. 22, 1996 and amylase variants having additional modification in the immediate parent available from Novo Nordisk A/S, disclosed in Wo 95/10603, published April 95. Also suitable are amylases described in EP 277 216, WO 95/26397 and WO 96/23873 (all by Novo Nordisk).

Examples of commercial a-amylases products are Purafect Ox Am&commat; from Genencor and Termamyl&commat;' Ban, Fungamyl&commat; and Duramylo, all available from Novo Nordisk A/S Denmark. WO 95/26397 describes other suitable amylases; aamylases characterised by having a specific activity at least 25% higher than the specific activity of Termamylt) at a temperature range of 25 C to 55 C and at a pH value in the range of 8 to 10, measured by the Phadebas a-amylase activity assay. Suitable are variants of the above enzymes, described in WO 96/23873 (Novo Nordisk). Other amylolytic enzymes with improved properties with respect to the activity level of the combination of thermostability and a higher activity level are described in WO 95/35382.

The amylolytic enzymes are incorporated in the detergent compositions of the present invention a level of from 0.0001% to 2%, preferably from 0.00018% to 0.06%, more preferably from 0.00024% to 0.048% pure enzyme by weight of the composition.

The above mentioned enzymes may be of any suitable origin, such as vegetable, animal, bacterial, fungal and yeast origin. Origin can further be mesophilic or extremophilic (psychrophilic, psychrotrophic, thermophilic, barophilic, alkalophilic, acidophilic or halophilic.) Purified or non-purified forms of these enzymes may be used. Nowadays, it is common practice to modify wildtype enzymes via protein/genetic engineering techniques in order to optimise their performance efficiency in the detergent compositions of the invention. For example, the variants may be designed such that the compatibility of the enzyme to commonly encountered ingredients of such compositions is increased.

Alternatively, the variant may be designed such that the optimal pH, bleach or chelant stability, catalytic activity and the like, of the enzyme variant is tailored to suit the particular cleaning application.

In particular, attention should be focuses on amino acids sensitive to oxidation in the case of bleach stability and on surface charges for the surfactant compatibility. The isoelectric point of such enzymes may be modified by the substitution of some charged amino acids, e.g. an increase in isoelectric point may help to improve compatibility with anionic surfactants. The stability of the enzymes may be further enhanced by the creation of e.g. additional salt bridges and enforcing calcium binding sites to increase chelant stability. Special attention must be paid to the cellulases as most of the cellulases have separate binding domains (CBD). Properties of such enzymes can be altered by modifications in these domains.

Said enzymes are normally incorporated in the detergent composition at levels of from 0.0001% to 2% of pure enzyme by weight of the detergent composition. The enzymes can be added as separate single ingredients (prills, granulates or stabilized liquids containing one enzyme) or as mixtures of two or more enzymes (e.g. as cogranulates).

Other suitable detergent ingredients that can be added are enzyme oxidation scavengers which are described in Copending European Patent application 92870018.6 filed on Jan. 31, 1992. Examples of such enzyme oxidation scavengers are ethoxylated tetraethylene polyamines.

A range of enzyme materials and means for their incorporation into synthetic detergent compositions is also disclosed in WO 9307263 A and WO 9307260 A to Genencor International, WO 8908694 A to Novo, and U.S. Pat. No. 3,553,139 Jan. 5, 1971 to McCarty et al. Suitable enzymes are described in U.S. Pat. No. 4,507,219 Hughes, Mar. 26, 1985. Enzyme materials useful for liquid detergent formulations, and their incorporation into such formulations, are disclosed in U.S. Pat. No. 4,261,868, Hora et al, Apr. 14, 1981. Enzymes for use in detergents can be stabilise by various techniques. Enzyme stabilisation techniques are disclosed and exemplified in U.S. Pat. No. 3,600,319, Aug. 17, 1971, Gedge et al, EP 199,405 and EP 200,586, Oct. 29, 1986, Venegas. Enzyme stabilisation are also described, for example, in U.S. Pat. No. 3,519,570. A useful Bacillus, sp. AC13 giving proteases, xylanases and cellulases, is described in WO 9401532.

Controlled Rate of Release

A means may be provided for controlling the rate of release of bleaching agent, particularly oxygen bleach to the wash solution.

Means for controlling the rate of release of the bleach may provide for controlled release of peroxide species to the wash solution. Such means could, for example, include controlling the release of any inorganic perhydrate salt, acting as a hydrogen peroxide source, to the wash solution.

The coating may therefore, for example, comprise material poorly digestible by the enzyme, or by use of a second coating of sufficient thickness that the kinetics of dissolution of the second coating provide the controlled rate of release. A suitable second coating is any one of those described above for the enzyme.

Other means of providing the required controlled release include mechanical means for altering the physical characteristics of the bleach to control its solubility and rate of release. Suitable protocols could include compression, mechanical injection, manual injection, and adjustment of the solubility of the bleach compound by selection of particle size of any particulate component.

Whilst the choice of particle size will depend both on the composition of the particulate component, and the desire to meet the desired controlled release kinetics, it is desirable that the particle size should be more than 500 micrometers, preferably having an average particle diameter of from 800 to 1200 micrometers.

Additional protocols for providing the means of controlled release include the suitable choice of any other components of the detergent composition matrix such that when the composition is introduced to the wash solution the ionic strength environment therein-provided enables the required controlled release kinetics to be achieved.

Bleaching Agent Coating

The coating material may be applied using various methods. Any coating material is typically present at a weight ratio of coating material to bleach of from 1:99 to 1:2, preferably from 1:49 to 1:9.

One method for applying the coating material involves agglomeration. Preferred agglomeration processes include the use of any of the organic binder materials described hereinabove. Any conventional agglomerator/mixer may be used including, but not limited to pan, rotary drum and vertical blender types. Molten coating compositions may also be applied either by being poured onto, or spray atomized onto a moving bed of bleaching agent.

Encapsulation techniques are known for both peroxygen and chlorine bleaches, such as in U.S. Pat. No. 4,126,573.

The coatings can be applied in a variety of well-known methods including tumbling the coating and coated compound in a rolling mill, spraying a solution or suspension of the coating into a fluidised bed of the compound to be coated, precipitating the coating from a solvent on to the compound to be coated which is in suspension in the solvent.

For chlorine bleaches the amount of encapsulates used in the compositions of the invention may vary within the range of about 0.5% to about 3% as available chlorine (Avcl). For peroxygen bleaching agents a suitable range will be from 0.5% to 3% avO (available oxygen).

Detersive Surfactant

The detergent compositions of the present invention preferably include surfactants wherein the surfactant can be selected from the group consisting of nonionic and/or anionic and/or cationic and/or ampholytic and/or zwitterionic and/or semipolar surfactants.

The surfactant is typically present at a level of from about 0.01% to about 60% by weight. More preferred levels of incorporation are from about 1% to about 35% by weight, most preferably from about 1% to about 30% by weight of detergent compositions.

The surfactant is preferably formulated to be compatible with the enzyme and bleach components present in the composition. In liquid or gel compositions the surfactant is most preferably formulated such that it promotes, or at least does not degrade, the stability of any enzyme in these compositions.

Preferred surfactants to be used according to the present invention comprise as a surfactant one or more of the nonionic and/or anionic surfactants described herein.

Polyethylene, polypropylene, and polybutylene oxide condensates of alkyl phenols are suitable for use as the nonionic surfactant of the present invention, with the polyethylene oxide condensates being preferred. These compounds include the condensation products of alkyl phenols having an alkyl group containing from about 6 to about 14 carbon atoms, preferably from about 8 to about 14 carbon atoms, in either a straight-chain or branched-chain configuration with the alkylene oxide. In a preferred embodiment, the ethylene oxide is present in an amount equal to from about 2 to about 25 moles, more preferably from about 3 to about 15 moles, of ethylene oxide per mole of alkyl phenol.

Commercially available nonionic surfactants of this type include Igepal™ CO630, marketed by the GAF Corporation; and Triton™ X-45, X-114, X-100 and X102, all marketed by the Rohm & Haas Company. These surfactants are commonly referred to as alkylphenol alkoxylates (e.g., alkyl phenol ethoxylates).

The condensation products of primary and secondary aliphatic alcohols with from about 1 to about 25 moles of ethylene oxide are suitable for use as the nonionic surfactant of the nonionic surfactant s of the present invention. The alkyl chain of the aliphatic alcohol can either be straight or branched, primary or secondary, and generally contains from about 8 to about 22 carbon atoms.

Preferred are the condensation products of alcohol having an alkyl group containing from about 8 to about 20 carbon atoms, more preferably from about 10 to about 18 carbon atoms, with from about 2 to about 10 moles of ethylene oxide per mole of alcohol. About 2 to about 7 moles of ethylene oxide and most preferably from 2 to 5 moles of ethylene oxide per mole of alcohol are present in said condensation products. Examples of commercially available nonionic surfactants of this type include Tergitol™ 15-S-9 (the condensation product of C11-C18 linear alcohol with 9 moles ethylene oxide), Tergitol™ 24-L-6 NMW (the condensation product of C12-C14 primary alcohol with 6 moles ethylene oxide with a narrow molecular weight distribution), both marketed by Union Carbide Corporation; Neodol™ 45-9 (the condensation product of C14-C18 linear alcohol with 9 moles of ethylene oxide), Neodol™ 23-3 (the condensation product of C12-C13 linear alcohol with 3.0 moles of ethylene oxide), Neodol™ 45-7 (the condensation product of C14-C18 linear alcohol with 7 moles of ethylene oxide), Neodol™ 45-5 (the condensation product of C14-C18 linear alcohol with 5 moles of ethylene oxide) marketed by Shell Chemical Company, Kyro™ EOB (the condensation product of C13-C18 alcohol with 9 moles ethylene oxide), marketed by The Procter & Gamble Company, and Genapol LA 030 or 050 (the condensation product of C12-C14 alcohol with 3 or 5 moles of ethylene oxide) marketed by Hoechst. Preferred range of HLB in these products is from 8-11 and most preferred from 8-10.

Also useful nonionic surfactants of the present invention are the alkylpolysaccharides disclosed in U.S. Pat. No. 4,565,647, having a hydrophobic group containing from about 6 to about 30 carbon atoms, preferably from about 10 to about 16 carbon atoms and a polysaccharide, e.g. a polyglycoside, hydrophilic group containing from about 1.3 to about 10, preferably from about 1.3 to about 3, most preferably from about 1.3 to about 2.7 saccharide units. Any reducing saccharide containing 5 or 6 carbon atoms can be used, e.g., glucose, galactose and galactosyl moieties can be substituted for the glucosyl moieties (optionally the hydrophobic group is attached at the 2-, 3-, 4-, etc. positions thus giving a glucose or galactose as opposed to a glucoside or galactoside). The intersaccharide bonds can be, e.g., between the one position of the additional saccharide units and the 2-, 3-, 4-, and/or 6-positions on the preceding saccharide units.

The condensation products of ethylene oxide with a hydrophobic base formed by the condensation of propylene oxide with propylene glycol are also suitable for use as the additional nonionic detersive surfactant of the present invention. The hydrophobic portion of these compounds will preferably have a molecular weight of from about 1500 to about 1800 and will exhibit water insolubility. The addition of polyoxyethylene moieties to this hydrophobic portion tends to increase the water solubility of the molecule as a whole, and the liquid character of the product is retained up to the point where the polyoxyethylene content is about 50% of the total weight of the condensation product, which corresponds to condensation with up to about 40 moles of ethylene oxide.

Examples of compounds of this type include certain of the commercially-available Plurafac™ LF404 and Pluronic™ surfactants, marketed by BASF.

Also suitable for use as the nonionic surfactant of the present invention, are the condensation products of ethylene oxide with the product resulting from the reaction of propylene oxide and ethylenediamine. The hydrophobic moiety of these products consists of the reaction product of ethylenediamine and excess propylene oxide, and generally has a molecular weight of from about 2500 to about 3000. This hydrophobic moiety is condensed with ethylene oxide to the extent that the condensation product contains from about 40% to about 80% by weight of polyoxyethylene and has a molecular weight of from about 5,000 to about 11,000. Examples of this type of nonionic surfactant include certain of the commercially available Tetronic™ compounds, marketed by BASF.

Suitable anionic surfactants to be used are linear alkyl benzene sulfonate, alkyl ester sulfonate, branched alkyl sulfonate, mid-branched alkyl sulfonate surfactants including linear esters of Cg-C20 carboxylic acids (i.e., fatty acids) which are sulfonated with gaseous S0₃ according to “The Journal of the American Oil Chemists Society”, 52 (1975), pp. 323-329. Suitable starting materials would include natural fatty substances as derived from tallow or palm oil.

Other suitable anionic surfactants include the alkyl sulfate surfactants which are water soluble salts or acids of the formula ROS0₃M wherein R preferably is a C10-C24 hydrocarbyl, preferably an alkyl or hydroxyalkyl having a C10-C20 alkyl component, more preferably a C12-C18 alkyl or hydroxyalkyl, and M is H or a cation, e.g., an alkali metal cation (e.g. sodium, potassium, lithium), or ammonium or substituted ammonium (e.g. methyl-, dimethyl-, and trimethyl ammonium cations and quaternary ammonium cations such as tetramethylammonium and dimethyl piperdinium cations and quaternary ammonium cations derived from alkylamines such as ethylamine, diethylamine, triethylamine, and mixtures thereof, and the like). Typically, alkyl chains of C12-C16 are preferred for lower wash temperatures (e.g. below about 50 C) and C16-C18 alkyl chains are preferred for higher wash temperatures (e.g. above about 50 C).

Other anionic surfactants useful for detersive purposes can also be included in the detergent compositions of the present invention. These can include salts (including, for example, sodium, potassium, ammonium, and substituted ammonium salts such as mono-, di- and triethanolamine salts) of soap, C18-C22 primary of secondary alkanesulfonates, C18-C24 olefinsulfonates, sulfonated polycarboxylic acids prepared by sulfonation of the pyrolyzed product of alkaline earth metal citrates, e.g., as described in British patent specification No. 1,082,179, C18-C24 alkylpolyglycolethersulfates (containing up to 10 mole of ethylene oxide); alkyl glycerol sulfonates, fatty acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinates (especially saturated and unsaturated C12-C18 monoesters) and diesters of sulfosuccinates (especially saturated and unsaturated C6-C12 diesters), acyl sarcosinates, sulfates of alkylpolysaccharides such as the sulfates of alkylpolyglucoside (the nonionic nonsulfated compounds being described below), branched primary alkyl sulfates, and alkyl polyethoxy carboxylates such as those of the formula RO(CH2CH20) k-CH2COO-M+ wherein R is a Cg-C22 alkyl, k is an integer from 1 to 10, and M is a soluble salt-forming cation. Resin acids and hydrogenated resin acids are also suitable, such as rosin, hydrogenated rosin, and resin acids and hydrogenated resin acids present in or derived from tall oil.

Further examples are described in “Surface Active Agents and Detergents” (Vol. I and 11 by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23 (herein incorporated by reference).

When included therein, the detergent compositions of the present invention typically comprise from 1% to 40%, preferably from 3% to 20% by weight of such anionic surfactants.

Optional Ingredients

Optional ingredients that may be used in a detergent composition are selected from; suspending agent, chelating agent, radical scavenger, antioxidant, stabiliser, soil suspending polymer, polymeric soil release agent, pH control agent, dye transfer inhibitor, solvent, suds control agent, suds booster, brightener, perfume, pigment, dyes or a mixture thereof.

When included therein, the detergent compositions of the present invention typically comprise from 0.1% to 10%, preferably from about 0.5% to 8% by weight of any one, or a mixture thereof, of the optional ingredients listed above.

1. A detergent composition comprising an enzyme and a coated bleaching agent, wherein the coating material of the bleaching agent is a substrate for the enzyme.

2. A detergent composition according to claim 1 wherein, the composition is a liquid.

3. A detergent composition according to claim 1 wherein, the material is selected from the group consisting of protein, either of animal or vegetal origin, starch, fat and a mixture thereof.

4. A detergent composition according to claim 3 wherein, the material is a protein.

5. A detergent composition according to claim 1 wherein, the enzyme is a protease.

6. A detergent composition according to claim 1 wherein, the bleaching agent is a halogen releasing bleach or an oxygen releasing bleach

7. A detergent composition according to claim 6 wherein, the bleaching agent has an average size from 100μ to 2500μ.

8. A detergent composition according to claim 1 wherein, the bleaching agent consists of a hydrogen peroxide source and an organic peroxyacid bleach precursor compound.

9. A detergent composition according to claim 2 wherein, the material is selected from the group consisting of protein, either of animal or vegetal origin, starch, fat and a mixture thereof.

10. A detergent composition according to claim 9 wherein, the material is a protein.

11. A detergent composition according to claim 7 wherein, the bleaching agent has an average size from 500μ to 2000μ.

12. A detergent composition according to claim 11 wherein, the bleaching agent has an average size from 700μ to 1500μ.
